(19) United States
(12) Patent Application Publication
(10) Pub. No.: US 2022/0145033 A1
(43) Pub. Date: May 12, 2022

(54) POLYOLEFIN-BASED RESIN FOAMED SHEET AND METHOD OF PRODUCING SAME

(71) Applicant: Toray Industries, Inc., Tokyo (JP)

(72) Inventors: Hideo Yogou, Otsu-shi, Shiga (JP); Hiroshi Ishida, Otsu-shi, Shiga (JP); Tadafumi Akiyama, Otsu-shi, Shiga (JP); Yoshiyuki Oka, Otsu-shi, Shiga (JP)

(21) Appl. No.: 17/437,823

(22) PCT Filed: Mar. 5, 2020
(86) PCT No.: PCT/JP2020/009392

§ 371 Date: Sep. 9, 2021

(30) Foreign Application Priority Data
Mar. 26, 2019 (JP) 2019-058887

(51) Int. Cl. C08J 9/00; C08J 9/10; C08J 9/228; C08L 23/06

(52) U.S. Cl. CPC C08J 9/0061; C08J 9/103; C08J 9/228; C08L 23/06; C08J 2201/026; C08L 2207/066; C08J 2203/04; C08J 2205/06; C08J 2323/06; C08L 2203/14; C08L 2205/025; C08J 2201/03

(57) ABSTRACT

A polyolefin-based resin foamed sheet includes a polyolefin-based resin, wherein a thickness of the foamed sheet is 0.05-0.5 mm, an apparent density is 200-500 kg/m³, a tensile strength at 100% elongation in at least one direction of a longitudinal direction (MD direction) and a width direction (TD direction) of the sheet is 3.5-12 MPa, and a ratio of a tensile breakage strength and the tensile strength at 100% elongation in at least one direction of the MD direction and the TD direction of the sheet is 1.0-1.8.

### TECHNICAL FIELD

This disclosure relates to a polyolefin-based resin foamed sheet which can be suitably used as various cushioning materials, sealants and the like in the fields of electricity, electronics, vehicles and the like, and a method of producing the same.

### BACKGROUND

Foamed materials using polyolefin-based resins are used as layered materials having an adhesive layer in various industrial fields because of their generally excellent flexibility, cushioning property and thermal insulation. Recently, polyolefin-based resin foamed materials are widely used as cushioning materials or sealants for devices having a display panel and mounted with a touch panel (mobile, smart phones and the like) or for products incorporated with a touch panel, and to the foamed materials used, it is required to protect the foamed materials from external factors such as impact and prevent the occurrence of failure or malfunction due to water invasion. Further, accompanying with miniaturization of equipment, respective members are being made thinner, and along with it, also for cushioning materials and sealants, investigation of similar thinning is being progressed. When cushioning materials or sealants become thinner, because the strengths thereof are lowered, when used as adhesive tapes, they are likely to be damaged when being restuck (reworked), that is, the reworkability tends to deteriorate.

To solve these problems, in view of the strength of the surface layer of a foamed material, examples of improving it have been exemplified (for example, JP 2018-172643 A). However, there is a fear that by increase of the strength of the surface layer, the foamed material becomes too hard, and the shock absorption may be reduced. Further, in WO 2016/159094, a closed cell foamed sheet capable of suppressing blurring of a liquid crystal panel (pooling) that occurs when pushing down becomes strong is described, and in JP 2016-108422 A, a polypropylene-based resin foamed sheet capable of preventing intrusion of water, dust or the like into electric/electronic equipment regardless its thickness is small is described, but in any of them, reworkability is not studied.

Accordingly, it could be helpful to provide a polyolefin-based resin foamed sheet good in reworkability and also good in shock absorption even if it is a thin foamed sheet, and a method of producing the same.

### SUMMARY

We thus provide:

(1) A polyolefin-based resin foamed sheet which is a foamed sheet comprising a polyolefin-based resin, characterized in that a thickness of the foamed sheet is 0.05-0.5 mm, an apparent density is 200-500 kg/m³, a tensile strength at 100% elongation in at least one direction of a longitudinal direction (MD direction) and a width direction (TD direction) of the sheet is 3.5-12 MPa, and a ratio of a tensile breakage strength and the tensile strength at 100% elongation in at least one direction of the MD direction and the TD direction of the sheet is 1.0-1.8.

(2) The polyolefin-based resin foamed sheet according to (1), wherein a degree of cross linking is 30-50%.

(3) The polyolefin-based resin foamed sheet according to (1) or (2), wherein the polyolefin-based resin is a polyethylene-based resin.

(4) The polyolefin-based resin foamed sheet according to (3), wherein an average density of the polyethylene-based resin is 905-940 kg/m³.

(5) The polyolefin-based resin foamed sheet according to any one of (1) to (4), wherein a 25% compression hardness defined in JIS K6767(1999) is 0.03-0.15 MPa.

(6) An adhesive sheet using a polyolefin-based resin foamed sheet according to any one of (1) to (5).

Further, we provide a method of producing a polyolefin-based resin foamed sheet according to any one of (1) to (5). Namely,

(7) a method of producing a polyolefin-based resin foamed sheet according to any one of (1) to (5), having a stretching step in at least one direction of the MD direction and the TD direction of the sheet at a stretching ratio of 150-250% and a stretching temperature of a melting point of a foamed material or lower.

A polyolefin-based resin foamed sheet can thus be provided which is good in reworkability and also good in shock absorption even if it is a thin foamed sheet.

### DETAILED DESCRIPTION

Hereinafter, our foamed sheets and methods will be explained in detail together with examples.

The sheet-shaped foamed material has a thickness of 0.05 to 0.5 mm. If the thickness of the foamed sheet is less than 0.05 mm, the shock absorption and cushioning property will be insufficient. On the other hand, if the thickness exceeds 0.5 mm, in particular, when it is used to fix parts forming an electronic/electric equipment to an equipment main body, it is not preferred because it cannot be achieved to make the electronic/electric equipment thinner.

The foamed sheet is mainly composed of an olefin-based resin, particularly a polyolefin-based resin. Although the polyolefin-based resin is not particularly limited, for example, exemplified is a polyethylene-based resin typified by a low-density polyethylene, a high-density polyethylene, a linear low-density polyethylene, a ultra-low-density polyethylene or the like (the definition of density described here is as follows. ultra-low density: less than 910 kg/m³, low density: 910 kg/m³ or more and 940 kg/m³ or less, high density: greater than 940 kg/m³ and 965 kg/m³ or less), a copolymer whose main component is an ethylene, or a polypropylene-based resin typified by a homo-polypropylene, an ethylene-propylene random copolymer, an ethylene-propylene block copolymer or the like, and further, any mixture thereof may be used.

As the above-described copolymer whose main component is an ethylene, for example, exemplified are ethylene-α-olefin copolymers obtained by copolymerization of an ethylene and an α-olefin having 4 or more carbon atoms (for example, ethylene, 1-butene, 1-pentene, 1-hexene, 4-methyl-1-pentene, 1-heptene, 1-octene and the like), an ethylene-vinyl acetate copolymers and the like.

The polyolefin-based resin is more preferably a polyethylene-based resin such as a low-density polyethylene, a linear low-density polyethylene or a ultra-low-density polyethylene, an ethylene-α-olefin copolymer or an ethylene-vinyl acetate copolymer. Further preferably, it is a low-density polyethylene, a linear low-density polyethylene, or a ultra-low-density polyethylene.

These polyolefin-based resins may be either one or a mixture of two or more. Most preferably, it is a sole resin of a low-density polyethylene, a linear low-density polyethylene, an ethylene-vinyl acetate copolymer, or a mixture thereof.

Further, although the average density of the polyolefin-based resin used for the foamed sheet is not particularly specified, it is preferably 905-940 kg/m³. If it is less than 905 kg/m³, the reworkability tends to be reduced, and if more than 940 kg/m³, the shock absorption tends to be inferior.

Further, a thermoplastic resin other than the polyolefin-based resin may be added as long as the properties of the foamed sheet are not significantly impaired. As the thermoplastic resin other than the polyolefin-based resin described here, exemplified are, in halogen-free resins, a polystyrene, acrylic resins such as a polymethylmethacrylate and styrene-acrylic acid copolymers, a styrene-butadiene copolymer, an ethylene-vinyl acetate copolymer, a polyvinyl acetate, a polyvinyl alcohol, a polyvinyl acetal, a polyvinyl pyrrolidone, petroleum resins, a cellulose, cellulose derivatives such as a cellulose acetate, a cellulose nitrate, a methyl cellulose, a hydroxymethyl cellulose and a hydroxypropyl cellulose, polyolefins such as a low-molecular-weight polyethylene, a high-molecular-weight polyethylene and a polypropylene, aromatic polyester resins such as a saturated alkyl polyester resin, a polyethylene terephthalate, a polybutylene terephthalate and a polyarylate, a polyamide resin, a polyacetal resin, a polycarbonate resin, a polyester sulfone resin, a polyphenylene sulfide resin, a polyether ketone resin, a vinyl polymerizable monomer, and a copolymer having a nitrogen-containing vinyl monomer. Further, exemplified are elastomers such as a polystyrene-based thermoplastic elastomer (SBC, TPS), a polyolefin-based thermoplastic elastomer (TPO), a vinyl chloride-based thermoplastic elastomer (TPVC), a polyurethane-based thermoplastic elastomer (TPU), a polyester-based thermoplastic elastomer (TPEE, TPC), a polyamide-based thermoplastic elastomer (TPAE, TPA), a polybutadiene-based thermoplastic elastomer (RB), a hydrogenated styrene-butadiene rubber (HSBR), block copolymers such as a styrene-ethylene butylene-olefin crystal block polymer (SEBC), an olefin crystal-ethylene butylene-olefin crystal block polymer (CEBC), a styrene-ethylene butylene-styrene block polymer (SEBS) and olefin block copolymers (OBC), and graft copolymers such as a polyolefin-vinyl-based graft copolymer, a polyolefin-amide-based graft copolymer, alpha-olefin copolymers, a polyolefin-acrylic-based graft copolymer and a polyolefin-cyclodextrin-based graft copolymer.

Further, in the resin containing a halogen, exemplified are a polyvinyl chloride, a polyvinylidene chloride, a polyvinylidene chloride ethylene trifluoride, a polyvinylidene fluoride resin, a fluorocarbon resin, a perfluorocarbon resin, a solvent-soluble perfluorocarbon resin and the like. These thermoplastic resins other than the polyolefin-based resins may be one kind or may be contained at a plurality of kinds. In particular, it is a preferable example to add an elastomer for the purpose of imparting flexibility and shock absorption, and the kind and amount are selected according to desired physical properties.

As long as the desired effects are not impaired, an antioxidant such as phenol-based, phosphorus-based, amine-based or sulfur-based one, a metal deactivator, fillers such as mica and talc, a flame retardant such as bromine-based or phosphorus-based one, a flame retardant auxiliary such as antimony trioxide, an antistatic agent, a lubricant, a pigment, and an additive such as polytetrafluoroethylene, can be added.

The polyolefin-based resin foamed sheet is produced by mixing a mixture of polyolefin-based resin with a blowing agent capable of generating a gas, and as a method of producing the same, exemplified are: atmospheric pressure foaming method of adding a thermal decomposition-type chemical blowing agent as the blowing agent to the mixture of polyolefin-based resin, melt kneading it, and foaming it by heating at an atmospheric pressure; extrusion foaming method of thermally decomposing a thermal decomposition-type chemical blowing agent in an extruder, and foaming it while extruding it under a high pressure; press foaming method of thermally decomposing a thermal decomposition-type chemical blowing agent in a press mold, and foaming it while reducing pressure; extrusion foaming method of melt mixing gas or vaporizing solvent in an extruder, and foaming it while extruding under a high pressure.

The thermal decomposition-type chemical blowing agent used here is a chemical blowing agent which is decomposed and releases gas by being applied with heat and, for example, an organic blowing agent such as azodicarbonamide, N,N′-dinitroso pentamethylene tetramine, or P,P′-oxybenzene sulfonyl hydrazide, and an inorganic blowing agent such as sodium bicarbonate, ammonium carbonate, ammonium bicarbonate or calcium azide, can be exemplified.

The blowing agent can be used alone or in combination of two or more kinds. To obtain a foamed sheet flexible and having a smooth surface, an atmospheric pressure foaming method using azodicarbonamide as the blowing agent is preferably used.

The resin composition can be melt-kneaded by an extruder such as a single-screw or twin-screw extruder or a tandem-type extruder, or a kneading device such as a mixing roll, a Banbury mixer or a kneader mixer. When an extruder is used, it is preferred to install a vacuum vent. Further, as needed, the respective resins and additives may be blended in advance with, for example, a V blender or a Henschel mixer, and then supplied to the extruder or the like.

Any of a resin foamed material having been cross-linked (hereinafter, referred to as a cross-linked foamed material) and a resin foamed material not having been cross-linked (hereinafter, referred to as a non-cross-linked foamed material) can be used, and an appropriate resin foamed material may be selected according to the application. However, a cross-linked foamed material is preferred as the polyolefin-based resin foamed sheet because the surface of the resin foamed material is smooth and the appearance is excellent.

As the method of producing the foamed sheet when the cross-linking is performed using an organic peroxide, the polyolefin-based resin, the organic peroxide and the thermal decomposition-type blowing agent are supplied to an extruder, and formed into a sheet, and a sheet of a foamable resin composition is obtained. By heating this sheet to a temperature higher than the decomposition temperature of the thermal decomposition-type blowing agent, thereby decomposing the organic peroxide, a desired foamed sheet is prepared by thermally decomposing the blowing agent while cross-linking the resin.

As the organic peroxide used when preparing the cross-linked foamed material, exemplified are dicumyl peroxide, 2,5-dimethyl-2,5-di-(t-butylperoxy)-hexyne-3, α,α′-bis(t-butyl peroxy diisopropyl) benzene, t-butyl peroxy cumene, 4,4′-di(t-butyl peroxy) valeric acid n-butyl ester, 1,1-di(t-butyl peroxy)-3,3,5-trimethylcyclohexane, 1,1-di(t-butyl peroxy) cyclohexane and the like. These are used usually in a range of 0.2 to 10 parts by mass relative to 100 parts by weight of the polyolefin-based resin in the raw material. If it is less than 0.2 parts by mass, the addition effect is not sufficient, and if it exceeds 10 parts by mass, the cross-linking proceeds too much, which is not preferred. Therefore, a chemical compound is preferably selected as the organic peroxide, whose decomposition temperature is higher than the kneading temperature of the resin composition and lower than the decomposition temperature of the thermal decomposition-type blowing agent.

As the method of producing the foamed sheet when the cross-linking is performed using an ionizing radiation, a polyolefin-based resin, a polyfunctional monomer and the thermal decomposition-type blowing agent are supplied to an extruder, and formed into a sheet, and a foamed sheet is obtained. By irradiating ionizing radiation to this sheet and cross-linking it, a cross-linked foamable sheet is obtained. As the ionizing radiation, for example, α-rays, β-rays, γ-rays, electron beams and the like can be exemplified. Although the irradiation dose of the ionizing radiation varies depending upon the target degree of cross-linking, the shape, the thickness of the object to be irradiated or the like, the irradiation dose is usually 1 to 20 Mrad, preferably 1 to 10 Mrad. If the irradiation dose is too small, because the cross-linking does not proceed sufficiently, the effect is insufficient, and if it is too large, there is a possibility that the resin may be decomposed, which is not preferred. Among these, the irradiation of electron beams is preferable because the resin can be efficiently cross-linked for the irradiated objects having various thicknesses by controlling the electron acceleration voltage. Further, the irradiation times of the ionizing radiation is not particularly restricted.

Then, the cross-linked foamable sheet is heated to a temperature higher than the decomposition temperature of the thermal decomposition-type blowing agent to decompose the blowing agent, thereby preparing a foamed sheet. As the heating method, a conventionally known method can be used and, for example, it can be carried out in a vertical or horizontal hot air faming furnace, or a chemical bath such as a molten salt.

Further, a method of thinning the foamed sheet prepared by these methods can be preferably used by employing a slicing for dividing the sheet in the thickness direction to make it thinner, a stretching processing for uniaxially or biaxially stretching the sheet while heating it, a compression processing for sandwiching a heated foamed sheet with rolls or the like, alone or in combination of two or more.

In the stretching processing, the cross-linked foamable sheet may be foamed to form a foamed sheet and then stretched, or the foamable sheet may be stretched while being foamed. It is preferred that the foamed sheet is stretched in at least one direction of an extrusion direction (longitudinal direction of the sheet: MD direction) and the direction perpendicular to the extrusion direction (width direction of the sheet: TD direction), and it is more preferred that it is stretched in both the MD direction and the TD direction. By stretching in both directions, anisotropy of the foamed sheet is removed, and it is not necessary to consider the directionality when using the foamed sheet.

With respect to the stretching ratio, although it may be decided so that the sheet has a desired thickness, from the viewpoint of the processability at the time of stretching, it is preferred to adjust the thickness of the foamed sheet before stretching so that the sheet can be processed at 150 to 250% of the stretching ratio. If the stretching ratio is less than 150%, it is difficult to adjust the tensile strength at 100% elongation within a desired range. Further, if it is larger than 250%, processing defects such as breakage are likely to occur during stretching processing.

Further, when the foamed sheet is stretched again by heating after cooling, if the stretching is performed by heating, for example, at 80-200° C., preferably at 80-160° C., processing defects such as breakage of the foamed sheet are hardly to occur during stretching processing. More preferably, by stretching at a temperature from 80° C. to a temperature below the melting point of the foamed sheet described later, it becomes possible to stretch the foamed sheet to a smaller thickness while improving the tensile strength at 100% elongation.

The degree of cross-linking of the polyolefin-based resin foamed sheet is preferably 30% to 50%. If this degree of cross-linking is less than 30%, the tensile strength of the foamed material is lowered, and the reworkability and the processability at the time of stretching processing are deteriorated. On the other hand, if the degree of cross-linking exceeds 50%, excessive cross-linking occurs and the tensile breakage elongation decreases.

The apparent density of the polyolefin-based resin foamed sheet is required to be 200 kg/m³ to 500 kg/m³. If the apparent density is less than 200 kg/m³, the strength of the foamed sheet is lowered, the reworkability is deteriorated, and the shock absorption is lowered, which are not preferred. If it exceeds 500 kg/m³, it becomes hard and the cushioning property is reduced, which are not preferred. More preferably, it is 300 kg/m³ to 500 kg/m³.

It is necessary that the tensile strength at 100% elongation in at least one direction of the longitudinal direction (MD direction) and the width direction (TD direction) of the sheet is 3.5-12 MPa. When less than 3.5 MPa, the strength at the time of rework is poor, the sheet is easily broken when peeled for rework. When larger than 12 MPa, because the strength of the foamed sheet becomes too high, and there is a possibility that the shock absorption may not be satisfactory. More preferably, it is 3.5 to 12 MPa in both the MD direction and the TD direction. If both directions are within the range, there is no need to pay attention to the direction of re-sticking during rework. A further preferable range is 5.0 to 12.0 MPa.

Further, it is necessary that the ratio of the tensile breakage strength and the tensile strength at 100% elongation in at least one direction of the MD direction and the TD direction of the sheet (the tensile breakage strength/the tensile strength at 100% elongation) is 1.0-1.8. When this ratio is less than 1.0, it means that the strength at 100% elongation is larger than the tensile breakage strength, and a breakage of the material is likely to occur during rework. When greater than 1.8, because the tensile strength at 100% elongation is much weaker than the tensile breakage strength, a plastic deformation is likely to occur during rework. More preferably, it is 1.0 to 1.8 in both the MD direction and the TD direction. If both directions are within the range, there is no need to pay attention to the direction of re-sticking during rework. A further preferable range is 1.1 to 1.6.

It is preferred that the 25% compression hardness defined in JIS K6767(1999) is 0.03-0.15 MPa. When the 25% compression hardness is smaller than 0.03 MPa, the strength at the time of compression is low and a sufficient shock absorption cannot be obtained. On the other hand, when larger than 0.15 MPa, because the strength at the time of compression is too high, a sufficient shock absorption cannot be obtained. More preferably, it is 0.04 to 0.10 MPa.

The polyolefin-based resin foamed sheet has closed cells, and by having the closed cells, it is facilitated to control the sealability, the shock absorption and the like to be good. A preferable range of the rate of closed cells defined as described later is 80-100%, more preferable range is 90-100%, and further preferable range is 95-100%.

The average cell size of the polyolefin-based resin foamed sheet is not particularly limited, but a smaller one is preferable from the viewpoints of smooth surface, improved adhesion when formed into a laminated body, and flexibility. The average cell size of the foamed sheet in the MD and TD directions is preferably 150 μm-500 μm. More preferably, it is 190 to 300 μm.

Although the use of the polyolefin-based resin foamed sheet is not particularly limited, for example, it is preferably used inside an electronic device. Since the foamed sheet is a thin film, it can be suitably used inside a thin electronic device, for example, various portable electronic devices. As the portable electronic devices, exemplified are a notebook-type personal computer, a mobile phone, a smartphone, a tablet, a portable music device and the like. Inside the electronic devices, the foamed sheet can be suitably used as a shock absorption material for absorbing a shock, a sealant for filling a gap between members and the like. In actual use, an adhesive layer is provided on at least one surface of the foamed sheet, and it can be suitably used as an adhesive sheet using the polyolefin-based resin foamed sheet.

### EXAMPLES

Hereinafter, our foamed sheets and methods will be explained in more detail with reference to Examples. The raw materials used in the Examples and Comparative Examples are as follows, and the measurement methods and evaluation methods are as shown below.

Raw Materials

LLDPE (a-1): “EVOLUE-H” (registered trademark) SP4005, supplied by Prime Polymer Co., Ltd. (density: 940 kg/m³, MFR (190° C.)=0.45 g/10 minutes, melting point=127° C.) LLDPE (a-2): “NOVATEC” (registered trademark) UJ960, supplied by Japan Polyethylene Corporation (density: 935 kg/m³, MFR (190° C.)=5 g/10 minutes, melting point=126° C.) LLDPE (a-3): “NIPOLON” (registered trademark) F15R, supplied by Tosoh Corporation (density: 925 kg/m³, MFR (190° C.)=0.8 g/10 minutes, melting point=122° C.) LLDPE (a-4): “NIPOLON (registered trademark)-Z” HM300K, supplied by Tosoh Corporation (density: 900 kg/m³, MFR (190° C.)=4.0 g/10 minutes, melting point=93° C.) LDPE (b-1): “PETROSEN” (registered trademark) LW04-1, supplied by Tosoh Corporation (density: 940 kg/m³, MFR (190° C.)=6.5 g/10 minutes, melting point=131° C.) LDPE (b-2): “PETROSEN” (registered trademark) 183, supplied by Tosoh Corporation (density: 924 kg/m³, MFR (190° C.)=2.0 g/10 minutes, melting point=110° C.) Phenol-based antioxidant: “IRGANOX” (registered trademark) 1010, supplied by BASF Corporation

(1) Thickness of Foamed Sheet:

The thickness of a foamed sheet was measured according to ISO1923 (1981) “Measurement method of foamed plastics and rubber—Determination or linear dimensions”. Using a dial gauge equipped with a circular probe having an area of 10 cm², a foamed sheet cut to a certain size is stationarily placed on a flat table, and the thickness is measured at a condition of contacting the probe with the surface of the foamed sheet from above at a constant pressure of 10 g.

(2) Apparent Density of Foamed Sheet:

The apparent density of a foamed sheet is a value measured and calculated according to JIS K6767 (1999) “Cellular plastics-Polyethylene-Methods of test”. The thickness of a test piece of the foamed sheet cut into an area of 10 cm² is measured, and the mass of this test piece is weighed. The value obtained by the following equation is defined as an apparent density, and the unit is kg/m³.

apparent density (kg/m³)={mass of test piece (kg)/area of test piece 0.01 (m²)/thickness of test piece (m)}

(3) Degree of Cross-Linking of Foamed Material:

The degree of cross-linking of the foamed sheet is determined as follows. The foamed sheet is cut into about 0.5 mm square and about 100 mg is weighed with an accuracy of 0.1 mg. After immersing it in 200 ml of tetralin at a temperature of 140° C. for 3 hours, the mixture is naturally filtered through a 100 mesh stainless steel wire mesh, and the insoluble matter on the wire mesh is dried in a hot air oven at 120° C. for 1 hour. Then, it is cooled in a desiccator containing silica gel for 30 minutes, the mass of this insoluble matter is precisely weighed, and the degree of cross-linking of the foamed sheet is calculated as a percentage according to the following equation.

degree of cross-linking (%)={mass of insoluble matter (mg)/mass of weighed foamed sheet (mg)}×100

(4) Rate of Closed Cells:

The rate of closed cells of the foamed sheet was determined by the air pycnometer method described in ASTM-D2856 with an air comparative hydrometer 1000 type supplied by Tokyo Science Co., Ltd.

(5) Compression Hardness of Foamed Sheet:

The method of measuring 25% compression hardness as a compressive strength is in accordance with JIS K6767 (1999) “Cellular plastics-Polyethylene-Methods of test”. As the measuring device, the Tensilon universal testing machine UCT-500 supplied by Orientec Co., Ltd. is used.

(6) Average Cell Size of Foamed Sheet:

The average cell size of the foamed sheet is calculated as follows. The cross section of the foamed sheet was observed at a magnification of 50 times using a scanning electron microscope (SEM) (supplied by Hitachi High-Technologies Corporation, S-3000N), and using the obtained image and measurement software, the cell size (diameter) was measured. The cell size was measured as the maximum length of each cell in the direction along each of MD direction, TD direction and ZD direction within a range of 1.5 mm×1.5 mm in the image of the cross section taken at the above-described magnification in the direction along each of the sheet extrusion direction (longitudinal direction of the sheet: MD direction), the direction perpendicular to the extrusion direction (width direction of the sheet: TD direction), and the thickness direction (ZD direction), and the average cell size in each direction was calculated from 30 randomly selected measurement results. The cell size in the thickness direction (ZD direction) can be measured from an image of a cross section in either the MD direction or the TD direction, but in the respective Examples described later, the image of the cross section in the MD direction was used for the measurement.

(7) Method of Measuring Melting Point of Resin and Melting Point of Foamed Material:

The melting point of the used resin composition and the melting point of the foamed material are measured in accordance with JIS K7121 (1987) “Testing Methods for Transition Temperatures of Plastics”. Using a DSC, heating was carried out at a heating rate of 10° C./min up to a temperature higher by about 30° C. than that at the end of the melting peak, a curve was drawn, and the number at the peak top was read. In a foamed material using two kinds of raw materials, when two peak tops were confirmed, one with a larger peak top was taken as the melting point.

(8) Tensile Properties:

The tensile strength at 100% elongation, tensile breakage strength and tensile breakage elongation are determined in accordance with JIS K6767 (1999) “Cellular plastics-Polyethylene-Methods of test”. The determination is carried out as follows.

Using a punching blade of dumbbell shape No. 1 defined in JIS K6251: 2010, the foamed sheet was punched in the MD direction of the foamed sheet punching to obtain five test pieces. The foamed sheet was punched in the TD direction to obtain five test pieces. After conditioning the test pieces under a standard atmosphere at a temperature of 23° C. and a relative humidity of 50% for 16 hours or more, the measurement was carried out under the same standard atmosphere. The measurement was carried out at a distance between grippers of 50 mm and a test speed of 500 mm/min, and calculation was carried out by the method defined in JIS K6251: 2010. However, the elongation was calculated from the distance between the grippers. As the measuring device, the Tensilon universal testing machine UCT-500 supplied by Orientec Co., Ltd. was used.

(9) Shock Absorbing Energy:

The obtained foamed sheet was processed into a 10 cm square and a ball drop test was carried out. In the test method, using a ball drop test apparatus with a cradle having a size of (vertical) 85 mm×(horizontal) 85 mm×(height) 50 mm, a foamed sheet controlled at 23° C. was placed on the cradle, the test was carried out by dropping rigid balls, a weight of each of which is known, onto the center of the foamed sheet from a height of 100 cm in order from a lighter-weight ball, and an energy calculated by the following equation from the weight when the foamed sheet was cracked for the first time was defined as the shock absorbing energy.

Shock absorbing energy (J/mm)=(weight of rigid ball (kg)×acceleration (9.8 m/s²)×height (1 m))/thickness of foamed sheet (mm)

(10) Peel Strength:

The peel strength is measured in accordance with JIS Z0237 (2009). The measurement is carried out as follows.

The obtained foamed sheet was punched in the MD and TD directions with a punching blade (25 mm×200 mm). Thereafter, an adhesive was applied to one surface of the sheet by a length of 100 mm, and it was adhered to a SUS plate. As the adhesive, “PPX” (registered trademark) supplied by Cemedine Co., Ltd. was used. When pasted, it was pressed three times with a 2 kg roller. Then, after leaving it for 24 hours, the unadhered portion and the SUS plate were grasped, and the peel strength was measured at a speed of 300 mm/min. As the measuring device, the Tensilon universal testing machine UCT-500 supplied by Orientec Co., Ltd. was used.

(11) Reworkability:

The adhesive processing was carried out in each of the MD and TD directions of the foamed sheet at a width of 5 mm and a length of 100 mm. The obtained adhesive sheet was pressed onto a SUS plate three times with a 2 kg roller, after it is left at 23° C. for 20 minutes to be stuck, the quality, when it was peeled off, was visually determined according to the following criteria.

◯: In a tape prepared by applying an adhesive onto the foamed sheet, even if it is restuck, it can be used without causing breaking or elongating of the foamed sheet.

Δ: When it is restuck, the foamed sheet is deformed and not returned.

×: When it is restuck, the foamed sheet is broken.

### EXAMPLE 1

50 parts by mass of LLDPE (a-2) and 50 parts by mass of LDPE (b-2) as a polyolefin-based resin, 2.5 parts by mass of azodicarbonamide which is a thermal decomposition-type blowing agent, and 0.5 part by mass of phenol-based antioxidant were supplied to an extruder and melt kneaded at 130° C. The foamable composition prepared by kneading the supplied respective components was extruded from the extruder to obtain a foamable sheet with a thickness of 0.50 mm. Next, an electron beam was irradiated to the foamable sheet from both surface sides to achieve 7.5 Mrad, and the foamable sheet was cross-linked to obtain a cross-linked foamable sheet. The cross-linked foamable sheet was continuously fed into a foaming furnace maintained at 240° C. by an infrared heater for the upper surface and a salt bath for the lower surface to heat and foam the sheet to obtain a foamed sheet. The melting point of the foamed sheet was 115° C. Then, after cooling once, a foamed sheet was obtained by stretching at 110° C. at the stretching ratios in the MD and TD directions shown in Table 1 so that the total thickness became the thickness shown in Table 1. The obtained foamed sheet was evaluated according to the aforementioned evaluation methods. The results are shown in Table 1.

### EXAMPLE 2

50 parts by mass of LLDPE (a-3) and 50 parts by mass of LDPE (b-2) as a polyolefin-based resin, 2.5 parts by mass of azodicarbonamide which is a thermal decomposition-type blowing agent, and 0.5 part by mass of phenol-based antioxidant were supplied to an extruder and melt kneaded at 130° C. Others were followed to the conditions of the method described in Example 1 and by stretching at the stretching ratios in the MD and TD directions shown in Table 1, a foamed sheet was obtained. The melting point of the foamed sheet was 113° C. The obtained foamed sheet was evaluated according to the aforementioned evaluation methods. The results are shown in Table 1.

### EXAMPLE 3

50 parts by mass of LLDPE (a-3) and 50 parts by mass of LDPE (b-2) as a polyolefin-based resin, 4.5 parts by mass of azodicarbonamide which is a thermal decomposition-type blowing agent, and 0.5 part by mass of phenol-based antioxidant were supplied to an extruder and melt kneaded at 130° C. The foamable composition prepared by kneading the supplied respective components was extruded from the extruder to obtain a foamable sheet with a thickness of 0.50 mm. Others were followed to the conditions of the method described in Example 1 to perform electron beam irradiation and foaming, and by stretching at the stretching ratios in the MD and TD directions shown in Table 1, a foamed sheet was obtained. The melting point of the foamed sheet was 113° C. The obtained foamed sheet was evaluated according to the aforementioned evaluation methods. The results are shown in Table 1.

### EXAMPLE 4

50 parts by mass of LLDPE (a-3) and 50 parts by mass of LDPE (b-2) as a polyolefin-based resin, 2.5 parts by mass of azodicarbonamide which is a thermal decomposition-type blowing agent, and 0.5 part by mass of phenol-based antioxidant were supplied to an extruder and melt kneaded at 130° C. The foamable composition prepared by kneading the supplied respective components was extruded from the extruder to obtain a foamable sheet with a thickness of 0.50 mm. Next, an electron beam was irradiated to the foamable sheet from both surface sides to achieve 5.5 Mrad, and the foamable sheet was cross-linked to obtain a cross-linked foamable sheet. The melting point of the foamed sheet was 113° C. Others were followed to the conditions of the method described in Example 1 to perform electron beam irradiation and foaming, and by stretching at the stretching ratios in the MD and TD directions shown in Table 1, a foamed sheet was obtained. The obtained foamed sheet was evaluated according to the aforementioned evaluation methods. The results are shown in Table 1.

### EXAMPLE 5

50 parts by mass of LLDPE (a-3) and 50 parts by mass of LDPE (b-2) as a polyolefin-based resin, 4.5 parts by mass of azodicarbonamide which is a thermal decomposition-type blowing agent, and 0.5 part by mass of phenol-based antioxidant were supplied to an extruder and melt kneaded at 130° C. The foamable composition prepared by kneading the supplied respective components was extruded from the extruder to obtain a foamable sheet with a thickness of 0.50 mm. Others were followed to the conditions of the method described in Example 4 to perform electron beam irradiation and foaming, and by stretching at the stretching ratios in the MD and TD directions shown in Table 1, a foamed sheet was obtained. The melting point of the foamed sheet was 113° C. The obtained foamed sheet was evaluated according to the aforementioned evaluation methods. The results are shown in Table 1.

### EXAMPLE 6

A foamed sheet was obtained by the conditions of the method described in Example 1 and by stretching at the conditions of the stretching ratios shown in Table 1, other than a condition where the foamable composition prepared by kneading the supplied respective components was extruded from the extruder to obtain a foamable sheet with a thickness of 1.00 mm. The melting point of the foamed sheet was 115° C. The obtained foamed sheet was evaluated according to the aforementioned evaluation methods. The results are shown in Table 1.

### EXAMPLE 7

A foamed sheet was obtained by the conditions of the method described in Example 1 and by stretching at the stretching ratios in the MD and TD directions shown in Table 1, other than a condition where an electron beam was irradiated to the foamable sheet from both surface sides to achieve 8.5 Mrad. The obtained foamed sheet was evaluated according to the aforementioned evaluation methods. The melting point of the foamed sheet was 115° C. The results are shown in Table 1.

### EXAMPLE 8

50 parts by mass of LLDPE (a-1) and 50 parts by mass of LDPE (b-1) as a polyolefin-based resin, 2.5 parts by mass of azodicarbonamide which is a thermal decomposition-type blowing agent, and 0.5 part by mass of phenol-based antioxidant were supplied to an extruder and melt kneaded at 130° C. The foamable composition prepared by kneading the supplied respective components was extruded from the extruder to obtain a foamable sheet with a thickness of 0.50 mm. Others were followed to the conditions of the method described in Example 1 to perform electron beam irradiation and foaming, and by stretching at the stretching ratios in the MD and TD directions shown in Table 1, a foamed sheet was obtained. The melting point of the foamed sheet was 129° C. The obtained foamed sheet was evaluated according to the aforementioned evaluation methods. The results are shown in Table 1.

### COMPARATIVE EXAMPLE 1

100 parts by mass of LLDPE (a-4) as a polyolefin resin, 2.5 parts by mass of azodicarbonamide which is a thermal decomposition-type blowing agent, and 0.5 part by mass of phenol-based antioxidant were supplied to an extruder and melt kneaded at 130° C. The foamable composition prepared by kneading the supplied respective components was extruded from the extruder to obtain a foamable sheet with a thickness of 0.50 mm. Next, an electron beam was irradiated to the foamable sheet from both surface sides to achieve 10 Mrad, and the foamable sheet was cross-linked to obtain a cross-linked foamable sheet. The cross-linked foamable sheet was continuously fed into a foaming furnace maintained at 240° C. by an infrared heater for the upper surface and a salt bath for the lower surface to heat and foam the sheet to obtain a foamed sheet. The melting point of the foamed sheet was 93° C. Then, after cooling once, a foamed sheet was obtained by stretching at 110° C. at the stretching ratios in the MD and TD directions shown in Table 2 so that the total thickness became the thickness shown in Table 2. The obtained foamed sheet was evaluated according to the aforementioned evaluation methods. The results are shown in Table 2.

### COMPARATIVE EXAMPLE 2

100 parts by mass of LLDPE (a-4) and 50 parts by mass of LDPE (b-2) as a polyolefin-based resin, 6.5 parts by mass of azodicarbonamide which is a thermal decomposition-type blowing agent, and 0.5 part by mass of phenol-based antioxidant were supplied to an extruder and melt kneaded at 130° C. The foamable composition prepared by kneading the supplied respective components was extruded from the extruder to obtain a foamable sheet with a thickness of 0.50 mm. Next, an electron beam was irradiated to the foamable sheet from both surface sides to achieve 7.5 Mrad, and the foamable sheet was cross-linked to obtain a cross-linked foamable sheet. The cross-linked foamable sheet was continuously fed into a foaming furnace maintained at 240° C. by an infrared heater for the upper surface and a salt bath for the lower surface to heat and foam the sheet to obtain a foamed sheet. Then, after cooling once, a foamed sheet was obtained by stretching at 110° C. at the stretching ratios in the MD and TD directions shown in Table 2 so that the total thickness became the thickness shown in Table 2. The melting point of the foamed sheet was 108° C. The obtained foamed sheet was evaluated according to the aforementioned evaluation methods. The results are shown in Table 2.

### COMPARATIVE EXAMPLE 3

A foamed sheet was obtained by the conditions described in Comparative Example 2 and the stretching ratios shown in Table 2, other than a condition where an electron beam was irradiated to the foamable sheet from both surface sides to achieve 4.5 Mrad. The melting point of the foamed sheet was 108° C. The obtained foamed sheet was evaluated according to the aforementioned evaluation methods. The results are shown in Table 2.

### COMPARATIVE EXAMPLE 4

A foamed sheet was obtained by the conditions described in Comparative Example 2 other than a condition where the stretching ratio was 130% in each of the MD and TD directions. The melting point of the foamed sheet was 108° C. The results are shown in Table 2.

### COMPARATIVE EXAMPLE 5

100 parts by mass of LDPE (b-2) as a polyolefin resin, 6.5 parts by mass of azodicarbonamide which is a thermal decomposition-type blowing agent, and 0.5 part by mass of phenol-based antioxidant were supplied to an extruder and melt kneaded at 130° C. The foamable composition prepared by kneading the supplied respective components was extruded from the extruder to obtain a foamable sheet with a thickness of 0.50 mm. Next, an electron beam was irradiated to the foamable sheet from both surface sides to achieve 7.5 Mrad, and the foamable sheet was cross-linked to obtain a cross-linked foamable sheet. The cross-linked foamable sheet was continuously fed into a foaming furnace maintained at 240° C. by an infrared heater for the upper surface and a salt bath for the lower surface to heat and foam the sheet to obtain a foamed sheet. The melting point of the foamed sheet was 110° C. In the following step, the stretching processing was not carried out. The obtained foamed sheet was evaluated according to the aforementioned evaluation methods. The results are shown in Table 2.

As shown in Table 1, in Examples 1 to 3 and 6 to 8 satisfying our conditions, good reworkabilities were obtained in both the MD direction and the TD direction. In Examples 4 and 5, because the stretching ratio in the TD direction was lowered, only the strength ratio in the TD direction deviated from our condition, but the strength ratio in the MD direction fell within our range, and at least in the MD direction, good reworkabilities were obtained. As shown in Table 2, good results were not obtained in Comparative Examples 1 to 5 that did not satisfy our conditions.

TABLE 1

| | | | | Example | | | | | | | |
|---|---|---|---|---|---|---|---|---|---|---|---|
| | | | | 1 | 2 | 3 | 4 | 5 | 6 | 7 | 8 |
| Composition | LLDPE(a-1) | | | | | | | | | | 50 |
| | LLDPE(a-2) | | Parts by | 50 | | | | | | | |
| | | | mass | | | | | | | | |
| | LLDPE(a-3) | | Parts by | | 50 | 50 | 50 | 50 | 50 | 50 | |
| | | | mass | | | | | | | | |
| | LLDPE(a-4) | | Parts by | | | | | | | | |
| | | | mass | | | | | | | | |
| | LDPE(b-1) | | Parts by | | | | | | | | 50 |
| | | | mass | | | | | | | | |
| | LDPE(b-2) | | Parts by | 50 | 50 | 50 | 50 | 50 | 50 | 50 | |
| | | | mass | | | | | | | | |
| | Average density | | (kg/m³) | 929 | 924 | 924 | 924 | 924 | 924 | 924 | 940 |
| Condition | Stretching | | ° C. | 110 | 110 | 110 | 110 | 110 | 110 | 110 | 110 |
| of | temperature | | | | | | | | | | |
| processing | Stretching | MD | (%) | 200 | 200 | 200 | 200 | 180 | 200 | 200 | 200 |
| | ratio | TD | (%) | 200 | 200 | 200 | 100 | 100 | 200 | 200 | 200 |
| Properties | Physical | Apparent density | (kg/m³) | 450 | 430 | 210 | 400 | 220 | 430 | 430 | 400 |
| | properties | of foamed sheet | | | | | | | | | |
| | | Degree of | (%) | 35 | 35 | 35 | 30 | 30 | 35 | 40 | 35 |
| | | cross-linking | | | | | | | | | |
| | | Thickness of | (mm) | 0.10 | 0.10 | 0.10 | 0.20 | 0.21 | 0.50 | 0.10 | 0.10 |
| | | sheet | | | | | | | | | |
| | | Cell size (MD) | (μm) | 252 | 261 | 283 | 351 | 387 | 378 | 224 | 261 |
| | | Cell size (TD) | (μm) | 202 | 208 | 228 | 160 | 176 | 256 | 192 | 208 |
| | | Cell size (ZD) | (μm) | 14 | 14 | 16 | 33 | 35 | 43 | 12 | 14 |
| | | Rate of closed | (%) | 95 | 95 | 95 | 95 | 96 | 95 | 95 | 95 |
| | | cells | | | | | | | | | |
| | Melting point of | | ° C. | 115 | 113 | 113 | 113 | 113 | 115 | 115 | 129 |
| | foamed sheet | | | | | | | | | | |
| | Tensile breakage | MD | (MPa) | 13.8 | 11.5 | 4.5 | 10.5 | 4.2 | 11.0 | 14.0 | 15.5 |
| | strength | TD | (MPa) | 7.3 | 6.0 | 4.5 | 4.8 | 3.1 | 5.8 | 8.0 | 8.5 |
| | Tensile breakage | MD | (%) | 200 | 220 | 250 | 250 | 250 | 230 | 180 | 170 |
| | elongation | TD | (%) | 220 | 245 | 250 | 410 | 500 | 250 | 250 | 200 |
| | Tensile strength at | MD | (MPa) | 10.5 | 10.0 | 3.6 | 8.8 | 3.5 | 9.5 | 11.5 | 11.0 |
| | 100% elongation | TD | (MPa) | 5.9 | 5.2 | 3.5 | 1.9 | 1.2 | 5.0 | 7.5 | 7.0 |
| | Strength ratio | MD | (—) | 1.3 | 1.2 | 1.3 | 1.2 | 1.2 | 1.2 | 1.2 | 1.4 |
| | | TD | (—) | 1.2 | 1.2 | 1.3 | 2.5 | 2.6 | 1.2 | 1.1 | 1.2 |
| | Compression | 25% compression | (MPa) | 0.090 | 0.050 | 0.030 | 0.050 | 0.030 | 0.050 | 0.050 | 0.140 |
| | strength | hardness | | | | | | | | | |
| | Properties of | Shock absorbing | (J/mm) | 1.20 | 1.06 | 0.90 | 0.90 | 0.85 | 1.10 | 1.20 | 1.40 |
| | foamed sheet | energy | | | | | | | | | |
| | | Peel strength | (N/mm) | 1.08 | 0.92 | 0.83 | 0.83 | 0.60 | 0.92 | 1.10 | 1.23 |
| | | (MD) | | | | | | | | | |
| | | Peel strength | (N/mm) | 0.61 | 0.50 | 0.81 | 0.30 | 0.21 | 0.50 | 0.70 | 0.78 |
| | | (TD) | | | | | | | | | |
| | | Reworkabilily | (—) | ∘ | ∘ | ∘ | ∘ | ∘ | ∘ | ∘ | ∘ |
| | | (MD) | | | | | | | | | |
| | | Reworkability | (—) | ∘ | ∘ | ∘ | Δ | x | ∘ | ∘ | ∘ |
| | | (TD) | | | | | | | | | |

TABLE 2

| | | | | Comparative Example | | | | |
|---|---|---|---|---|---|---|---|---|
| | | | | 1 | 2 | 3 | 4 | 5 |
| Composition | LLDPE(a-1) | | Parts by | | | | | |
| | | | mass | | | | | |
| | LLDPE(a-2) | | Parts by | | | | | |
| | | | mass | | | | | |
| | LLDPE(a-3) | | Parts by | | 50 | 50 | 50 | |
| | | | mass | | | | | |
| | LLDPE(a-4) | | Parts by | 100 | | | | |
| | | | mass | | | | | |
| | LDPE(b-1) | | Parts by | | | | | |
| | | | mass | | | | | |
| | LDPE(b-2) | | Parts by | | 50 | 50 | 50 | 100 |
| | | | mass | | | | | |
| | Average density | | (kg/m³) | 900 | 924 | 924 | 924 | 924 |
| Condition | Stretching | | ° C. | 110 | 110 | 110 | 110 | — |
| of | temperature | | | | | | | |
| processing | Stretching | MD | (%) | 200 | 180 | 200 | 130 | 100 |
| | ratio | TD | (%) | 200 | 180 | 200 | 130 | 100 |
| Properties | Physical | Apparent density | (kg/m³) | 350 | 100 | 400 | 430 | 125 |
| | properties | of foamed sheet | | | | | | |
| | | Degree of | (%) | 30 | 35 | 25 | 35 | 30 |
| | | cross-linking | | | | | | |
| | | Thickness of | (mm) | 0.10 | 0.10 | 0.10 | 0.10 | 0.50 |
| | | sheet | | | | | | |
| | | Cell size (MD) | (μm) | 225 | 432 | 375 | 225 | 432 |
| | | Cell size (TD) | (μm) | 184 | 232 | 275 | 184 | 232 |
| | | Cell size (ZD) | (μm) | 12 | 16 | 14 | 32 | 72 |
| | | Rate of closed | (%) | 92 | 96 | 95 | 95 | 95 |
| | | cells | | | | | | |
| | Melting point of | | ° C. | 93 | 108 | 108 | 108 | 110 |
| | foamed sheet | | | | | | | |
| | Tensile breakage | MD | (MPa) | 7.5 | 2.5 | 8.5 | 7.2 | 1.9 |
| | strength | TD | (MPa) | 5.7 | 2.3 | 5.0 | 5.3 | 0.9 |
| | Tensile breakage | MD | (%) | 675 | 180 | 250 | 370 | 200 |
| | elongation | TD | (%) | 307 | 120 | 290 | 300 | 133 |
| | Tensile strength at | MD | (MPa) | 2.5 | 1.6 | 2.8 | 2.5 | 1.8 |
| | 100% elongation | TD | (MPa) | 3.0 | 1.3 | 2.6 | 2.3 | 1.1 |
| | Strength ratio | MD | (—) | 3.0 | 1.6 | 3.0 | 2.9 | 1.1 |
| | | TD | (—) | 1.9 | 1.8 | 1.9 | 2.3 | 0.8 |
| | Compression | 25% compression | (MPa) | 0.038 | 0.020 | 0.035 | 0.100 | 0.100 |
| | strength | hardness | | | | | | |
| | Properties of | Shock absorbing | (J/mm) | 0.89 | 0.80 | 0.80 | 1.20 | 1.20 |
| | foamed sheet | energy | | | | | | |
| | | Peel strength | (N/mm) | 0.48 | 0.43 | 0.60 | 0.55 | 0.35 |
| | | (MD) | | | | | | |
| | | Peel strength | (N/mm) | 0.58 | 0.35 | 0.56 | 0.51 | 0.21 |
| | | (TD) | | | | | | |
| | | Reworkability | (—) | Δ | x | Δ | x | x |
| | | (MD) | | | | | | |
| | | Reworkability | (—) | Δ | x | Δ | x | x |
| | | (TD) | | | | | | |

### INDUSTRIAL APPLICABILITY

Our foamed sheet can be suitably used particularly when a cushioning material or a shock absorbing material is provided for electronic/electric equipment such as a mobile phone.

1.-7. (canceled)

8. A polyolefin-based resin foamed sheet comprising a polyolefin-based resin, wherein a thickness of the foamed sheet is 0.05-0.5 mm, an apparent density is 200-500 kg/m³, a tensile strength at 100% elongation in at least one direction of a longitudinal direction (MD direction) and a width direction (TD direction) of the sheet is 3.5-12 MPa, and a ratio of a tensile breakage strength and the tensile strength at 100% elongation in at least one direction of the MD direction and the TD direction of the sheet is 1.0-1.8.

9. The polyolefin-based resin foamed sheet according to claim 8, wherein a degree of cross linking is 30-50%.

10. The polyolefin-based resin foamed sheet according to claim 8, wherein the polyolefin-based resin is a polyethylene-based resin.

11. The polyolefin-based resin foamed sheet according to claim 10, wherein an average density of the polyethylene-based resin is 905-940 kg/m³.

12. The polyolefin-based resin foamed sheet according to claim 8, wherein a 25% compression hardness defined in JIS K6767(1999) is 0.03-0.15 MPa.

13. The polyolefin-based resin foamed sheet according to claim 9, wherein a 25% compression hardness defined in JIS K6767(1999) is 0.03-0.15 MPa.

14. The polyolefin-based resin foamed sheet according to claim 10, wherein a 25% compression hardness defined in JIS K6767(1999) is 0.03-0.15 MPa.

15. The polyolefin-based resin foamed sheet according to claim 11, wherein a 25% compression hardness defined in JIS K6767(1999) is 0.03-0.15 MPa.

16. An adhesive sheet comprising the polyolefin-based resin foamed sheet according to claim 8.

17. An adhesive sheet comprising the polyolefin-based resin foamed sheet according to claim 9.

18. An adhesive sheet comprising the polyolefin-based resin foamed sheet according to claim 10.

19. An adhesive sheet comprising the polyolefin-based resin foamed sheet according to claim 11.

20. A method of producing the polyolefin-based resin foamed sheet according to claim 8, comprising a stretching step in at least one direction of the MD direction and the TD direction of the sheet at a stretching ratio of 150-250%, and a stretching temperature of a melting point of a foamed material or lower.

21. A method of producing the polyolefin-based resin foamed sheet according to claim 9, comprising a stretching step in at least one direction of the MD direction and the TD direction of the sheet at a stretching ratio of 150-250%, and a stretching temperature of a melting point of a foamed material or lower.

22. A method of producing the polyolefin-based resin foamed sheet according to claim 10, comprising a stretching step in at least one direction of the MD direction and the TD direction of the sheet at a stretching ratio of 150-250%, and a stretching temperature of a melting point of a foamed material or lower.

23. A method of producing the polyolefin-based resin foamed sheet according to claim 11, comprising a stretching step in at least one direction of the MD direction and the TD direction of the sheet at a stretching ratio of 150-250%, and a stretching temperature of a melting point of a foamed material or lower.
